(19) United States
(12) Patent Application Publication
(10) Pub. No.: US 2010/0163522 A1
(43) Pub. Date: Jul. 1, 2010

(54) METHOD FOR MANUFACTURING A WRITE POLE OF A MAGNETIC WRITE HEAD FOR MAGNETIC DATA RECORDING

(76) Inventors: Aron Pentek, San Jose, CA (US); Sue Siyang Zhang, Saratoga, CA (US); Yi Zheng, San Ramon, CA (US)

Correspondence Address: ZILKA-KOTAB, PC- HIT, P.O. BOX 721120, SAN JOSE, CA, 95172-1120, US

(21) Appl. No.: 12/345,804

(22) Filed: Dec. 30, 2008

(51) Int. Cl. B44C 1/22; B05D 5/12

(52) U.S. Cl. 216/22; 427/131

(57) ABSTRACT

A method for manufacturing a magnetic write head. The write head is constructed by a method that includes depositing a magnetic write pole material and then depositing a hard mask over the magnetic material. An inorganic image transfer layer is formed over the hard mask. SiC, alumina, SiO₂, SiN, Ta or TaOx. This image transfer is physically robust, so that it does not bend or tip over during manufacture. The image of a patterned photoresist layer can be transferred onto the underlying image transfer layer, and an ion milling can be performed to pattern the image of the image transfer layer onto the underlying hard mask and magnetic material, thereby forming a magnetic write pole.

### FIELD OF THE INVENTION

The present invention relates to perpendicular magnetic recording and more particularly to a method for manufacturing a write pole using an inorganic mask that has strong physical robustness at very narrow track-widths.

### BACKGROUND OF THE INVENTION

The heart of a computer's long term memory is an assembly that is referred to as a magnetic disk drive. The magnetic disk drive includes a rotating magnetic disk, write and read heads that are suspended by a suspension arm adjacent to a surface of the rotating magnetic disk and an actuator that swings the suspension arm to place the read and write heads over selected circular tracks on the rotating disk. The read and write heads are directly located on a slider that has an air bearing surface (ABS). The suspension arm biases the slider toward the surface of the disk, and when the disk rotates, air adjacent to the disk moves along with the surface of the disk. The slider flies over the surface of the disk on a cushion of this moving air. When the slider rides on the air bearing, the write and read heads are employed for writing magnetic transitions to and reading magnetic transitions from the rotating disk. The read and write heads are connected to processing circuitry that operates according to a computer program to implement the writing and reading functions.

The write head has traditionally included a coil layer embedded in first, second and third insulation layers (insulation stack), the insulation stack being sandwiched between first and second pole piece layers. A gap is formed between the first and second pole piece layers by a gap layer at an air bearing surface (ABS) of the write head and the pole piece layers are connected at a back gap. Current conducted to the coil layer induces a magnetic flux in the pole pieces which causes a magnetic field to fringe out at a write gap at the ABS for the purpose of writing the aforementioned magnetic transitions in tracks on the moving media, such as in circular tracks on the aforementioned rotating disk.

In recent read head designs, a GMR or TMR sensor has been employed for sensing magnetic fields from the rotating magnetic disk. The sensor includes a nonmagnetic conductive layer, or barrier layer, sandwiched between first and second ferromagnetic layers, referred to as a pinned layer and a free layer. First and second leads are connected to the sensor for conducting a sense current therethrough. The magnetization of the pinned layer is pinned perpendicular to the air bearing surface (ABS) and the magnetic moment of the free layer is located parallel to the ABS, but free to rotate in response to external magnetic fields. The magnetization of the pinned layer is typically pinned by exchange coupling with an antiferromagnetic layer.

The thickness of the spacer layer is chosen to be less than the mean free path of conduction electrons through the sensor. With this arrangement, a portion of the conduction electrons is scattered by the interlaces of the spacer layer with each of the pinned and free layers. When the magnetizations of the pinned and free layers are parallel with respect to one another, scattering is minimal and when the magnetizations of the pinned and free layer are antiparallel, scattering is maximized. Changes in scattering alter the resistance of the spin valve sensor in proportion to cos Θ, where Θ is the angle between the magnetizations of the pinned and free layers. In a read mode the resistance of the spin valve sensor changes proportionally to the magnitudes of the magnetic fields from the rotating disk. When a sense current is conducted through the spin valve sensor, resistance changes cause potential changes that are detected and processed as playback signals.

In order to meet the ever increasing demand for improved data rate and data capacity, researchers have recently been focusing their efforts on the development of perpendicular recording systems. A traditional longitudinal recording system, such as one that incorporates the write head described above, stores data as magnetic bits oriented longitudinally along a track in the plane of the surface of the magnetic disk. This longitudinal data bit is recorded by a fringing field that forms between the pair of magnetic poles separated by a write gap.

A perpendicular recording system, by contrast, records data as magnetizations oriented perpendicular to the plane of the magnetic disk. The magnetic disk has a magnetically soft underlayer covered by a thin magnetically hard top layer. The perpendicular write head has a write pole with a very small cross section and a return pole having a much larger cross section. A strong, highly concentrated magnetic field emits from the write pole in a direction perpendicular to the magnetic disk surface, magnetizing the magnetically hard top layer. The resulting magnetic flux then travels through the soft underlayer, returning to the return pole where it is sufficiently spread out and weak that it will not erase the signal recorded by the write pole when it passes back through the magnetically hard top layer on its way back to the return pole.

### SUMMARY OF THE INVENTION

The present invention provides a method for manufacturing a magnetic write head. The write head is constructed by a method that includes depositing a magnetic write pole material and then depositing a hard mask over the magnetic material. An inorganic image transfer layer is formed over the hard mask. This image transfer is physically robust, so that it does not bend or tip over during manufacture. The image of a patterned photoresist layer can be transferred onto the underlying image transfer layer, and an ion milling can be performed to pattern the image of the image transfer layer onto the underlying hard mask and magnetic material, thereby forming a magnetic write pole.

The image inorganic image transfer layer is preferably SiC, but can also be constructed of alumina, SiO₂, SiN, Ta or TaOx.

These and other features and advantages of the invention will be apparent upon reading of the following detailed description of preferred embodiments taken in conjunction with the Figures in which like reference numerals indicate like elements throughout.

### BRIEF DESCRIPTION OF THE DRAWINGS

For a fuller understanding of the nature and advantages of this invention, as well as the preferred mode of use, reference should be made to the following detailed description read in conjunction with the accompanying drawings which are not to scale.

FIG. 1 is a schematic illustration of a disk drive system in which the invention might be embodied;

FIG. 2 is an ABS view of a slider, taken from line 2-2 of FIG. 1, illustrating the location of a magnetic head thereon;

FIG. 3 is a cross sectional view of a magnetic head, taken from line 3-3 of FIG. 2 and rotated 90 degrees counterclockwise, of a magnetic head according to an embodiment of the present invention;

FIG. 4 is a top down view of a write pole of the magnetic head of FIG. 3; and

FIGS. 5-17 are views of a write head in various intermediate stages of manufacture, illustrating a method of manufacturing a magnetic write head according to an embodiment of the invention.

### DETAILED DESCRIPTION OF THE EMBODIMENTS

The following description is of the best embodiments presently contemplated for carrying out this invention. This description is made for the purpose of illustrating the general principles of this invention and is not meant to limit the inventive concepts claimed herein.

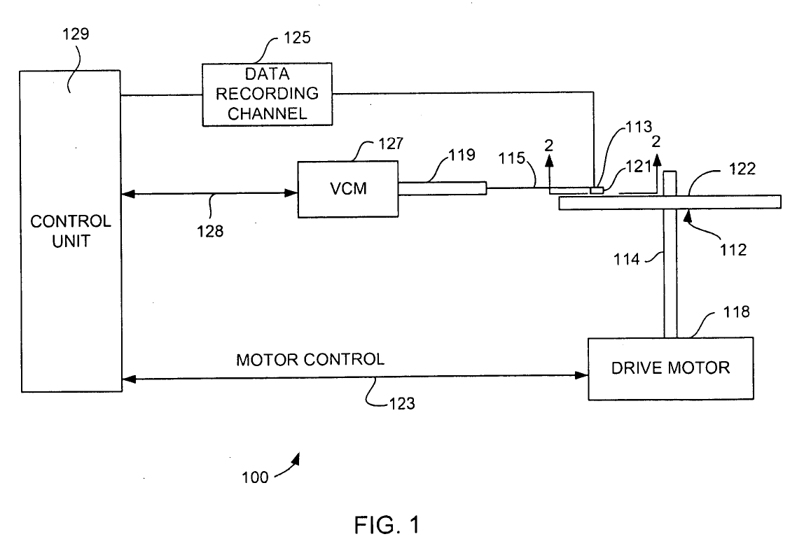

Referring now to FIG. 1, there is shown a disk drive 100 embodying this invention. As shown in FIG. 1, at least one rotatable magnetic disk 112 is supported on a spindle 114 and rotated by a disk drive motor 118. The magnetic recording on each disk is in the form of annular patterns of concentric data tracks (not shown) on the magnetic disk 112.

At least one slider 113 is positioned near the magnetic disk 112, each slider 113 supporting one or more magnetic head assemblies 121. As the magnetic disk rotates, slider 113 moves radially in and out over the disk surface 122 so that the magnetic head assembly 121 may access different tracks of the magnetic disk where desired data are written. Each slider 113 is attached to an actuator arm 119 by way of a suspension 115. The suspension 115 provides a slight spring force which biases slider 113 against the disk surface 122. Each actuator arm 119 is attached to an actuator means 127. The actuator means 127 as shown in FIG. 1 may be a voice coil motor (VCM). The VCM comprises a coil movable within a fixed magnetic field, the direction and speed of the coil movements being controlled by the motor current signals supplied by controller 129.

During operation of the disk storage system, the rotation of the magnetic disk 112 generates an air bearing between the slider 113 and the disk surface 122 which exerts an upward force or lift on the slider. The air bearing thus counter-balances the slight spring force of suspension 115 and supports slider 113 off and slightly above the disk surface by a small, substantially constant spacing during normal operation.

The various components of the disk storage system are controlled in operation by control signals generated by control unit 129, such as access control signals and internal clock signals. Typically, the control unit 129 comprises logic control circuits, storage means and a microprocessor. The control unit 129 generates control signals to control various system operations such as drive motor control signals on line 123 and head position and seek control signals on line 128. The control signals on line 128 provide the desired current profiles to optimally move and position slider 113 to the desired data track on disk 112. Write and read signals are communicated to and from write and read heads 121 by way of recording channel 125.

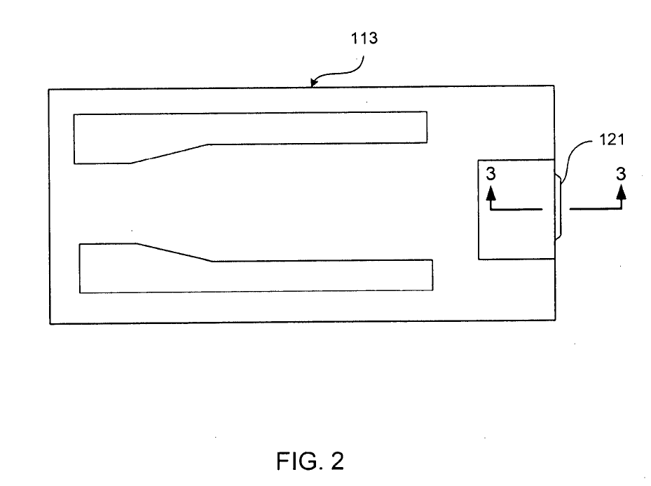

With reference to FIG. 2, the orientation of the magnetic head 121 in a slider 113 can be seen in more detail. FIG. 2 is an ABS view of the slider 113, and as can be seen the magnetic head including an inductive write head and a read sensor, is located at a trailing edge of the slider. The above description of a typical magnetic disk storage system, and the accompanying illustration of FIG. 1 are for representation purposes only. It should be apparent that disk storage systems may contain a large number of disks and actuators, and each actuator may support a number of sliders.

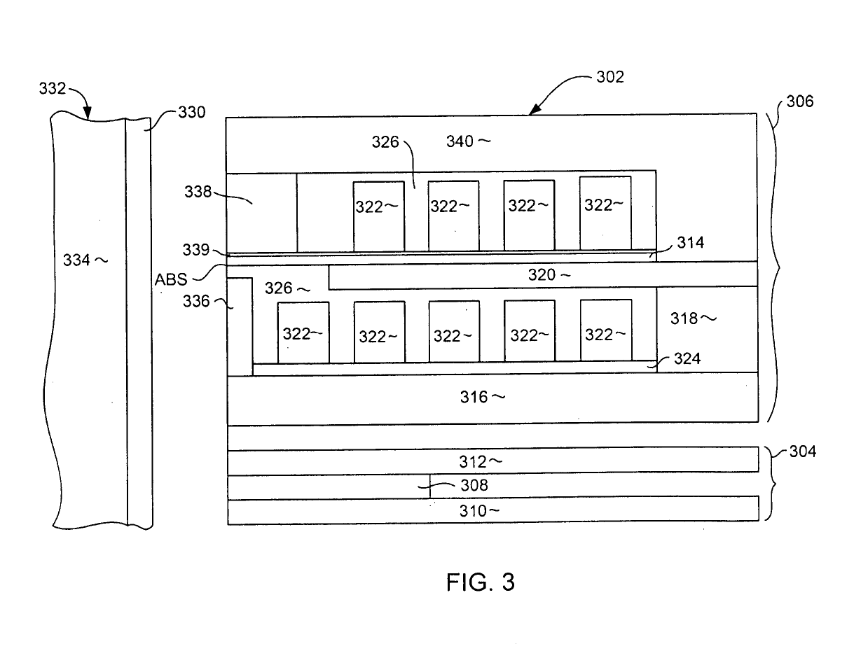

With reference now to FIG. 3, the invention can be embodied in a magnetic head 302. The magnetic head 302 includes a read head 304 and a write head 306. The read head 304 includes a magnetoresistive sensor 308, which can be a GMR, TMR, or some other type of sensor. The magnetoresistive sensor 308 is located between first and second magnetic shields 310, 312.

The write head 306 includes a magnetic write pole 314 and a magnetic return pole 316. The write pole 314 can be formed upon a magnetic shaping layer 320, and a magnetic back gap layer 318 magnetically connects the write pole 314 and shaping layer 320 with the return pole 316 in a region removed from the air bearing surface (ABS). A write coil 322 (shown in cross section in FIG. 3) passes between the write pole and shaping layer 314, 320 and the return pole 316, and may also pass above the write pole 314 and shaping layer 320. The write coil 322 can be a helical coil or can be one or more pancake coils. The write coil 322 can be formed upon an insulation layer 324 and can be embedded in a coil insulation layer 326 such as alumina and or hard baked photoresist.

In operation, when an electrical current flows through the write coil 322. A resulting magnetic field causes a magnetic flux to flow through the return pole 316, back gap 318, shaping layer 320 and write pole 314. This causes a magnetic write field to be emitted from the tip of the write pole 314 toward a magnetic medium 332. The write pole 314 has a cross section at the ABS that is much smaller than the cross section of the return pole 316 at the ABS. Therefore, the magnetic field emitting from the write pole 314 is sufficiently dense and strong that it can write a data bit to a magnetically hard top layer 330 of the magnetic medium 332. The magnetic flux then flows through a magnetically softer under-layer 334, and returns back to the return pole 316, where it is sufficiently spread out and weak that it does not erase the data bit recorded by the write pole 314. A magnetic pedestal 336 may be provided at the air bearing surface ABS and attached to the return pole 316 to prevent stray magnetic fields from the write coil 322 from affecting the magnetic signal recorded to the medium 332.

In order to increase write field gradient, and therefore increase the speed with which the write head 306 can write data, a trailing, wrap-around magnetic shield 338 can be provided. The trailing, wrap-around magnetic shield 338 is separated from the write pole by a non-magnetic layer 339. The trailing shield 338 attracts the magnetic field from the write pole 314, which slightly cants the angle of the magnetic field emitting from the write pole 314. This canting of the write field increases the speed with which write field polarity can be switched by increasing the field gradient. A trailing magnetic return pole 340 can be provided and can be magnetically connected with the trailing shield 338. Therefore, the trailing return pole 340 can magnetically connect the trailing magnetic shield 338 with the back portion of the write pole 302, such as with the back end of the shaping layer 320 and with the back gap layer 318. The magnetic trailing shield is also a second return pole so that in addition to magnetic flux being conducted through the medium 332 to the return pole 316, the magnetic flux also flows through the medium 332 to the trailing return pole 340.

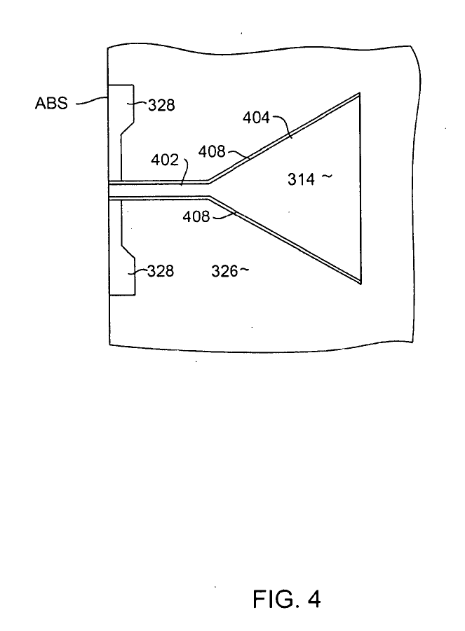

FIG. 4 shows a top down view of the write pole 314. As can be seen, the write pole 314 has a narrow pole tip portion 402 and a wider flared portion 404. The transition from the pole tip region 402 to the flared portion defines a flare point 404. As can be seen, the trailing, wrap-around shield 338 has side shield portions 328 that are separated from the write pole 314 by non-magnetic side gap layers 408.

In an effort to increase data density, the width of the pole tip 402 must be decreased in order to decrease the track width of the recorded data. As this width decreases, manufacturing methods previously used to define the write pole 314 run into serious challenges. One problem that presents itself relates to the physical integrity of the mask structure. Mask structures used to define a write pole have used materials such as organic polyimide materials as image transfer layers. An example of such as material is DURAMIDE® which has been used as a mask layer during ion milling to define the write pole.

However, as the width of the write pole decreases, the lack of physical strength of such materials causes them to bend, fall over or otherwise deform, resulting in write pole deformities. Furthermore, because the material removed during ion milling at the narrow pole tip portion 402 is greater than that at the wider flared portion 404, the pole tip inevitably ends up being over-etched.

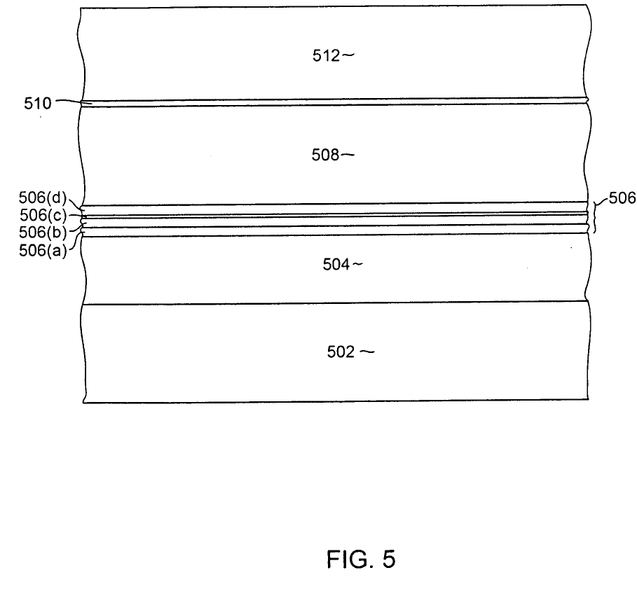

FIGS. 5-17 illustrate a method for manufacturing a write pole, such as the write pole 314 that overcomes these challenges, allowing for the accurate and reliable formation of a write pole having a very narrow track-width. With particular reference to FIG. 5, a substrate 502 is provided. This substrate can include all or a portion of the shaping layer 320 and insulation layer 326 described above with reference to FIG. 3.

A magnetic write pole material 504 is deposited over the substrate 502. The write pole material 504 can be a laminate structure that includes layers of high magnetic moment material separated by thin layers of non-magnetic material. A laminated, multi-layer hard mask structure 506 is deposited over the magnetic write pole material layer 504. An inorganic hard image transfer layer 508 is deposited over the laminate hard mask 506. The image transfer layer 508 can be a material such as SiC, SiO₂, SiN, Ta or TaOₓ, and is preferably SiC. The image transfer layer 508 can have a thickness of 4000 to 8000 Angstroms. A second hard mask layer 510 can be deposited over the image transfer layer 508. This second hard mask layer 510 can be a material such as Cr, NiCr, Ru or Rh and can have a thickness of 300 to 700 Angstroms. Finally, resist layer such as photoresist 512 is deposited over the second hard mask layer 510.

With continued reference to FIG. 5, the composition of the laminate hard mask 506 will be described in greater detail. The laminated hard mask includes a first hard mask layer 506(a) formed directly on top of the write pole material 504. This first hard mask layer is deposited to a thickness that is chosen to define a non-magnetic trailing gap thickness between the trailing edge of the write pole 504 and a trailing magnetic shield (yet to be formed). This first hard mask layer 506(a) can, therefore, be constructed of a material such as alumina and can be deposited to a thickness of, for example, 20 nm or less. This layer 506(a) could optionally be eliminated and a later deposition process used to define the trailing gap. A RIEable layer 506(b) is then deposited over the first hard mask layer 506(a). The RIEable layer 506(b) is constructed of a material that can be readily removed by reactive ion etching (i.e. a material having a high selectivity to reactive ion etching as compared with layer 506(a)) This layer 506(b) is preferably constructed of carbon or DLC, but could also be constructed of Ta, TaOx, SiC, SiOx or SiON. and is preferably deposited to a thickness of 10-30 nm. A thin end point detection layer 506(c) is deposited over the RIEable layer. The end point detection layer is constructed of a material that can be readily detected by an end point detection method such as Secondary Ion Mass Spectrometry (SIMS). The end point detection layer 506(c) is preferably TaOx, but could also be constructed of Ta, NiCr or NiFe with a thickness of 2˜5 nm. The layer 506(d) can be Al₂O₃ with the thickness of 0˜30 nm.

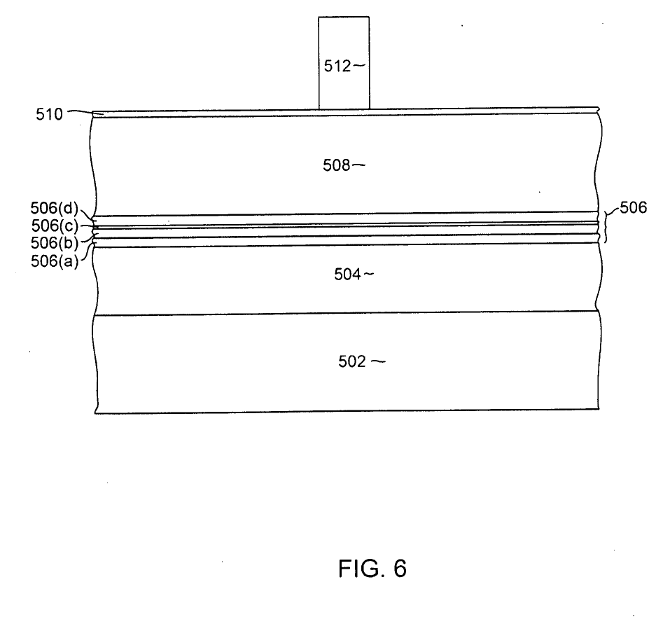

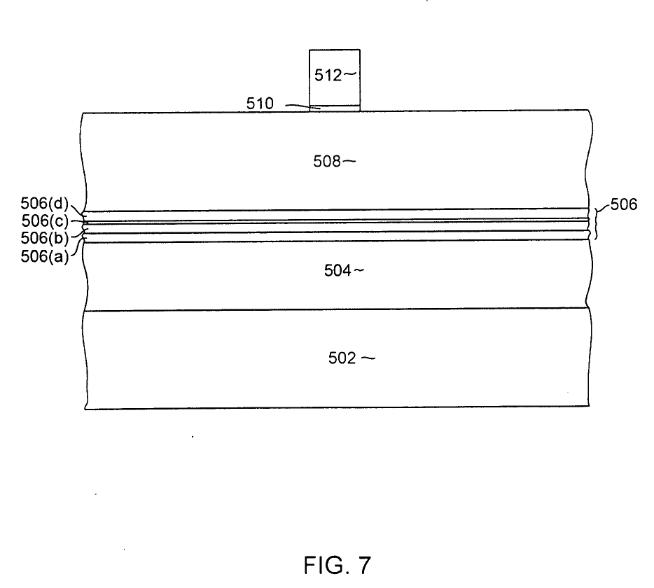

With reference to FIG. 6, the resist layer is photolithographically patterned and developed to form a desired write pole shape, shown in cross section in a plane parallel with the air bearing surface in FIG. 6. Then, a first ion milling operation is performed to transfer the image of the patterned resist mask 512 onto the underlying second hard mask layer 510 by removing portions of the hard mask 510 that are not protected by the resist mask 512, resulting in a structure such as shown in FIG. 7.

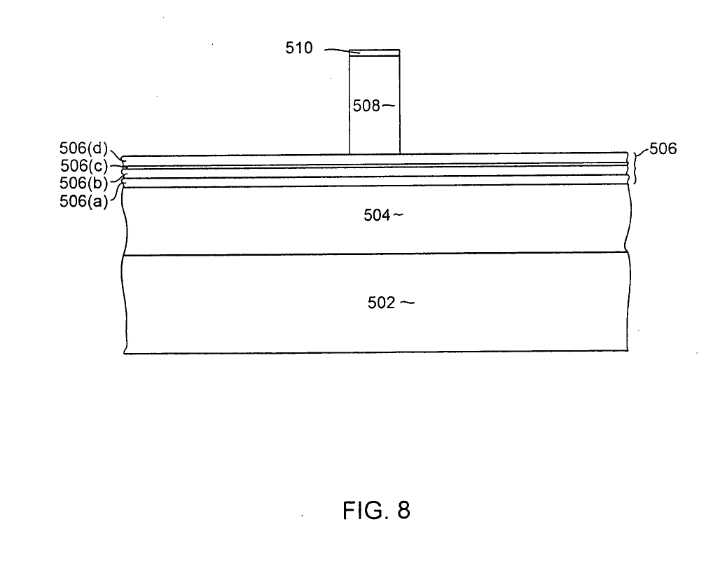

A reactive ion etching can then be performed to remove portions of the image transfer layer 508 that are not protected by the hard mask 510 to transfer the image of the hard mask 510 onto the image transfer layer. The reactive ion etching (RIE) is preferably performed using a chemistry that is chosen to preferentially remove the inorganic image transfer layer 508. For example, if the image transfer layer 508 is SiC, then the RIE can be performed using a SF₆ based chemistry. The structure is shown in FIG. 8.

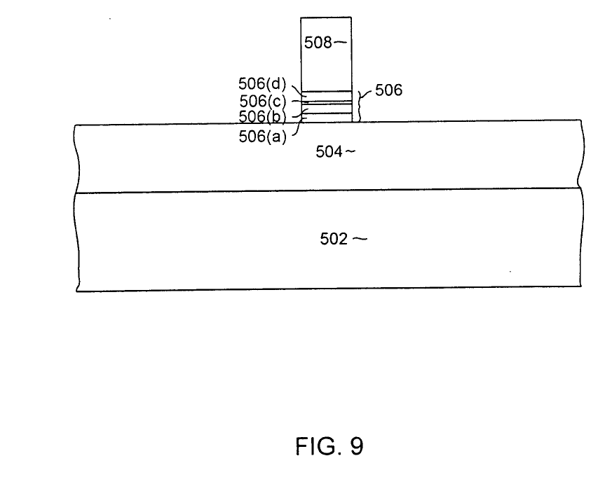

Then, one or more of ion milling and or reactive ion etching is performed to remove portions of the laminate hard mask structure 506 that is are not protected by the image transfer layer 508 to transfer the image of the image transfer layer 508 onto the underlying hard mask structure 506. This leaves a structure as shown in FIG. 9. As shown in FIG. 9, this consumes a portion of the image transfer layer, reducing the height of this layer 508.

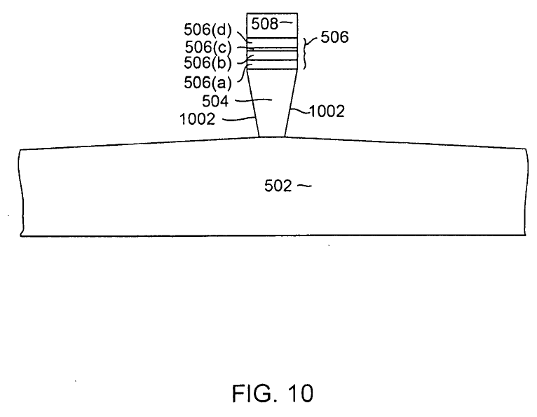

Then another ion milling is performed to remove portions of the magnetic write pole material 504 that are not protected by the hard mask structure 506 and remaining image transfer layer 508, leaving a structure as shown in FIG. 10. This ion milling is preferably a sweeping ion milling performed at one or more angles relative to normal in order to form the write pole 504 with tapered side walls 1002, as shown in FIG. 10.

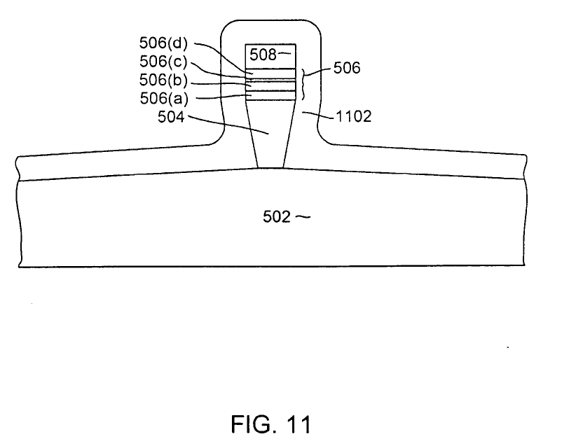

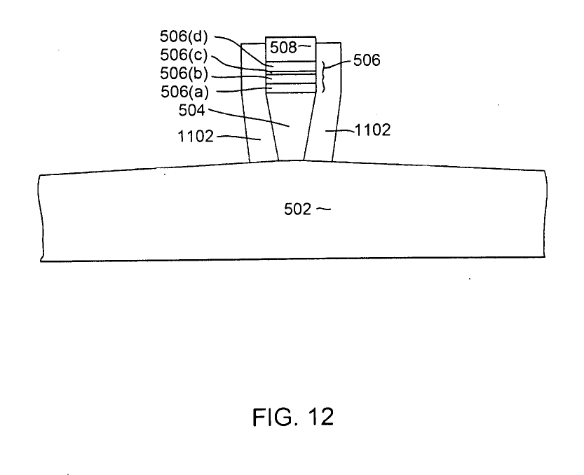

A layer of conformally deposited non-magnetic material 1102 is then deposited, as shown in FIG. 11. This layer 1102 is preferably alumina and is preferably deposited by atomic layer deposition. The layer 1102 is deposited to a thickness that is chosen to define a desired side gap thickness in the finished head, as will become clearer below. Another ion milling is then performed to preferentially remove horizontally disposed portions of the non-magnetic layer 1102 to expose the mask layer 508 and to form non-magnetic side walls 1102 on the side of the write pole 1102, resulting in a structure as shown in FIG. 12.

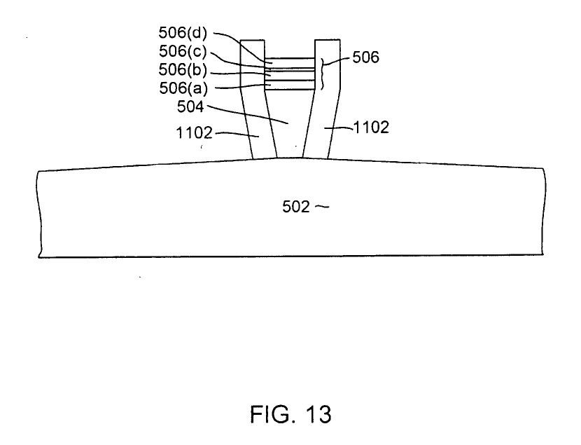

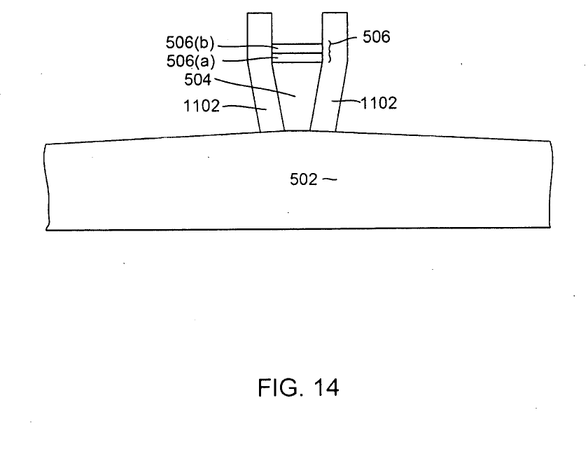

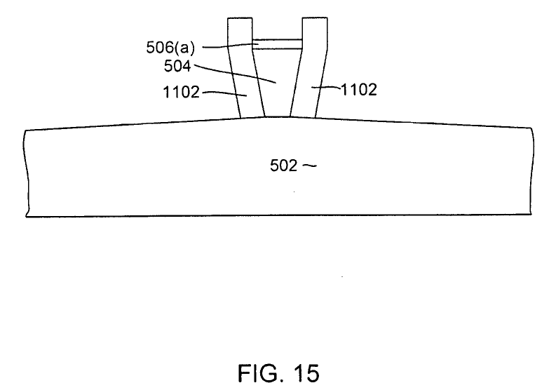

A reactive ion etching (RIE) is then performed to remove remaining portions of the image transfer layer 508. This results in a structure as shown in FIG. 13, with the non-magnetic side walls extending up above the exposed hard mask layer 506(d). Another ion milling (First hard mask ion milling) is then performed to remove the layer 506(d). This ion milling is terminated when the end point detection layer 506(c) is detected. An end point detection method such as Secondary Ion Mass Spectrometry (SIMS) can be used to detect the presence of the end point detection layer 506(c) to determine when the ion milling should be terminated. This results in a structure such shown in FIG. 14. Then, another reactive ion etching is performed to remove the RIEable layer 506(b), resulting in a structure as shown in FIG. 15. Because the reactive ion etching can be chosen to selectively remove the REIable layer 506(b) much more readily than the first hard mask layer 506(a), the as deposited thickness of the first hard mask layer 506(a) can be well maintained after the reactive ion etching. Therefore, the final trailing gap thickness of the shield (yet to be formed) can be well controlled by the as deposited thickness of the layer 506(a).

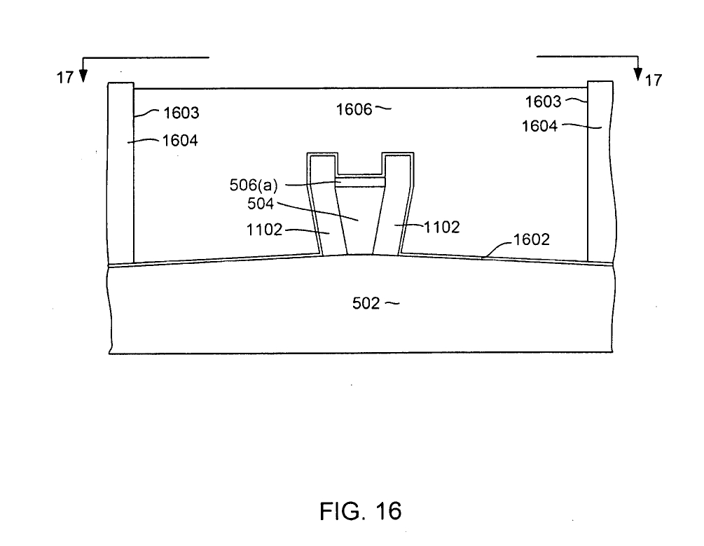

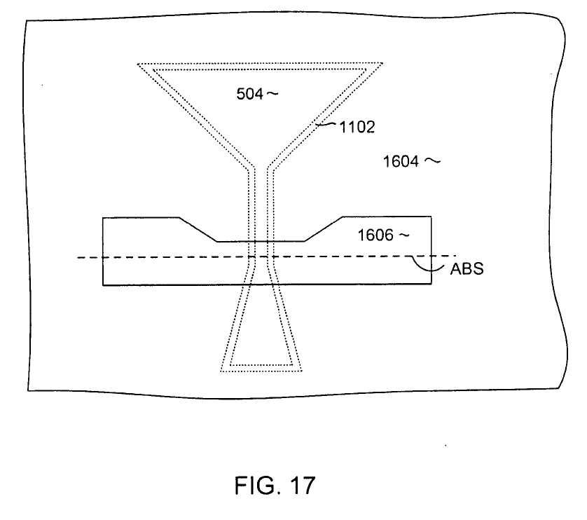

Then, with reference to FIG. 16, an electrically conductive electroplating seed layer 1602 is deposited. This seed layer can be a non-magnetic material such as Rh so that it functions as a part of the non-magnetic trailing gap. Therefore, the trailing gap layer 1602 is a combined thickness of the hard mask 506(a) and non-magnetic seed layer 1602. An electroplating frame mask 1604 is then formed over the seed layer 1602. The mask is configured with an opening 1603 that is configured to define the shape of a desired trailing magnetic shield, as can be seen, more clearly with reference to FIG. 17, which shows a top down view as taken from line 17-17 of FIG. 16. A magnetic material such as CoFe, NiFe or CoNiFe can then be electroplated into the opening 1603 to form a trailing magnetic shield. In FIG. 17, the location of an air bearing surface plane is indicated dashed line ABS. The location of the write pole 504 and side gap layer 1102 are shown in dotted line to indicate that they are hidden beneath the mask 1604 and shield 1606.

The above described use of an inorganic image transfer layer 508 (such as in FIG. 8) allows the write pole 504 to be constructed at a very narrow track width. The image transfer layer 508 has excellent physical robustness as compared with prior art image transfer layers such as DURMIDE®. As mentioned above, prior art image transfer layers tend to bend, fall over or otherwise deform when used at very narrow widths. The inorganic image transfer layer 508, however, mitigates this problem, providing the necessary physical strength to allow the formation of a write pole 504 having a very narrow track width.

While various embodiments have been described, it should be understood that they have been presented by way of example only, and not limitation. Other embodiments falling within the scope of the invention may also become apparent to those skilled in the art. Thus, the breadth and scope of the invention should not be limited by any of the above-described exemplary embodiments, but should be defined only in accordance with the following claims and their equivalents.

What is claimed is:

1. A method for manufacturing a write head for perpendicular magnetic data recording, comprising:
providing a substrate;
depositing a magnetic write pole material;
depositing a hard mask structure over the magnetic write pole material;
depositing an inorganic image transfer layer, wherein the image transfer layer comprises SiC, SiO₂, SiN, Ta or TaOx;
forming a resist mask, configured to define a write pole;
transferring the image of the resist mask onto the underlying image transfer layer and hard mask structure; and
performing an ion milling to remove portions of the magnetic write pole material that are not protected by the hard mask structure to form a write pole.

2. A method as in claim 1 further comprising after depositing the image transfer layer and before forming the resist mask, depositing a second hard mask structure, the method further comprising transferring the image of the resist mask onto the second hard mask structure.

3. A method as in claim 1 wherein the image transfer layer consists of SiC.

4. A method as in claim 1 wherein the image transfer layer comprises SiC having a thickness of 4000-8000 Angstroms.

5. A method as in claim 1 wherein the image transfer layer comprises SiC, alumina, SiO₂, SiN, Ta or TaOx deposited to a thickness of 4000-8000 Angstroms.

6. A method as in claim 1 wherein the hard mask structure comprises a layer of alumina formed directly on top of the magnetic write pole material, and further includes a RIEable layer and an end point detection layer.

7. A method as in claim wherein the hard mask structure comprises a first layer of alumina formed on the write pole material, a RIEable layer formed on the first layer of alumina, an end point detection layer formed on the RIEable layer, and a second layer of alumina formed over the end point detection layer.

8. A method as in claim 6 wherein the layer of alumina has a thickness not greater than 20 nm and the RIEable layer has a thickness of 10-30 nm.

9. A method as in claim 7 wherein wherein the first layer of alumina has a thickness of not greater than 20 nm, the RIEable layer has a thickness of 10-30 nm and the second layer of alumina has a thickness of 10-40 nm.

10. A method as in claim 6 wherein the RIEable layer comprises DLC.

11. A method as in claim 7 wherein the REIable layer comprises DLC, SiO2, SiNx, SiC, Ta or TaOx.

12. A method as in claim 6 wherein the end point detection layer comprises Ta

13. A method as in claim 6 wherein the end point detection layer comprises Ta, TaOx, NiCr or NiFe.

14. A method as in claim 7 wherein the end point detection layer comprises Ta

15. A method as in claim 7 wherein the end point detection layer comprises Ta, TaOx, NiCr or NiFe.

16. A method for manufacturing a write head for perpendicular magnetic data recording, comprising:
providing a substrate;
depositing a magnetic write pole material;
depositing a laminate hard mask structure over the magnetic write pole material, the laminated hard mask structure including a first alumina layer deposited on the write pole material, a RIEable material layer deposited on the first alumina layer, an end point detection layer deposited on the RIEable layer and a second alumina layer deposited on the end point detection layer;
depositing an inorganic image transfer layer;
forming a resist mask, configured to define a write pole;
transferring the image of the resist mask onto the underlying image transfer layer and hard mask structure;
performing an ion milling to remove portions of the magnetic write pole material that are not protected by the hard mask structure to form a write pole;
depositing alumina by atomic layer deposition;
performing a second ion milling to remove a portion of the alumina layer, the second ion milling being performed sufficiently to expose the inorganic image transfer layer;
performing a reactive ion etching to remove the inorganic image transfer layer;
performing a third ion milling to remove the second alumina layer of the hard mask structure, the third ion milling being terminated when the end point detection layer has been detected and removed;
performing a second reactive ion etching sufficiently to remove the RIEable layer;
depositing an electrically conductive seed layer;
forming a mask structure having an opening configured to define a wrap-around trailing magnetic shield; and
electroplating a magnetic material to form a wrap-around trailing magnetic shield.

17. A method as in claim 16 wherein the inorganic image transfer layer comprises SiC.

18. A method as in claim 16 wherein the inorganic image transfer layer comprises SiC, SiO₂, SiN, Ta or TaOₓ.

19. A method as in claim 16 wherein the RIEable material of the laminate hard mask comprises diamond like carbon, Ta, TaOx, SiC, SiOₓ or SiON.

20. A method as in claim 16 wherein the end point detection layer of the laminate hard mask comprises Ta, TaOx, NiCr or NiFe.
